(19) United States
(12) Patent Application Publication
(10) Pub. No.: US 2003/0002190 A1
(43) Pub. Date: Jan. 2, 2003

(54) Disk drive with optimized read gate delay

(76) Inventors: Song Wee Teo, Singapore (SG); Quek Leong Choo, Singapore (SG)

Correspondence Address: Kirk A. Cesari, Seagate Technolgy LLC, 1280 Disc Drive - SHK2LG, Shakopee, MN, 55379, US

(21) Appl. No.: 10/016,342

(22) Filed: Dec. 11, 2001

Related U.S. Application Data
(60) Provisional application No. 60/302,196, filed on Jun. 29, 2001.

(51) Int. Cl. G11B 15/12; G11B 5/09

(52) U.S. Cl. 360/63; 360/53

(57) ABSTRACT

A method is provided in which an optimal read gate delay duration for reading from a track of a hard disk drive is determined. The disk drive is of the type having read and write elements separated by an inter-element spacing and a platter including a plurality of radially spaced tracks. In one aspect the method comprises the steps of writing a bit pattern to a track, reading the bit pattern with each of a range of read gate delay durations, calculating a read bit error rate for each said duration and setting the optimal read gate delay to the delay duration corresponding to the lowest read bit error rate. In addition a computer program product, readable by a computer system for implementing the method is also provided.

### CROSS REFERENCE TO RELATED APPLICATIONS

This application claims the benefit of U.S. Provisional Application No. 60/302,196, filed Jun. 29, 2001.

### FIELD OF THE INVENTION

The present invention relates to a hard disk drive of the type that includes separate read and write head elements. More specifically the present invention concerns an improved disk drive adapted to overcome read errors due to variations in inter-element spacing, that is, the separation between read and write head elements.

### BACKGROUND TO THE INVENTION

FIG. 1 is a plan view of a conventional disk drive 2 with cover removed. The hard disk drive includes a stack of magnetic platters of which uppermost platter 4 is visible. Each platter comprises a rotatable storage disk operatively rotated at a constant speed of several thousand rpm by a spindle motor (not shown). Platter 4 typically comprises a disk substrate having a surface on which a magnetic material is deposited. Digital data is stored on the disk as a series of variations in magnetic orientation of the disk's magnetic material. The variations in magnetic orientation, generally comprising reversals of magnetic flux, represent binary digits of ones and zeroes that in turn represent data.

Data is written to and read from concentric tracks on each magnetic platter by read/write head 6 which includes a magneto-resistive (MR) head assembly. The MR head assembly produces, and detects, variations in magnetic orientation of the magnetic material as the disk rotates in order to write to and read from the track. With reference to FIG. 2 it will be observed that the read element 18 and the write element 20 are separated by an inter-element distance L. FIG. 3 depicts a further read-write head assembly in which the inter-element separation is narrower than in the head assembly shown in FIG. 2. The inter-element separation is narrower due to the manufacturing processes used to produce MR head assemblies. As a result the distance between the read and write elements of different units often varies so that the inter-element distance may decrease, for example to L-Δd, as shown in FIG. 3.

As will be explained, variation in the inter-element distance leads to difficulties in reading data from the tracks so that the read bit error rate increases thereby necessitating read retries and reducing data transfer rate from the disk drive. It is an object of the present invention to provide an apparatus and method that addresses this problem.

### BRIEF SUMMARY OF THE INVENTION

According to a first embodiment of the present invention there is provided a method for determining an optimal read gate delay duration for reading from a track of a hard disk drive, the disk drive being of the type having read and write elements separated by an inter-element spacing and a plurality of radially spaced tracks, the method comprising the steps of:

writing a bit pattern to the track;

reading the bit pattern with each of a range of read gate delay durations;

calculating a read bit error rate for each said duration; and

setting the optimal read gate delay to the delay duration corresponding to the lowest read bit error rate.

Preferably the method further includes the step of determining the optimal read gate delay duration for each track of the hard disk drive.

The method may include the step of recording the optimal read gate delay duration for each track of the hard disk drive in a memory device accessible to a controller of the hard disk drive.

In a preferred embodiment data is encoded on the tracks according to a zoned bit arrangement, the method further including the step of recording the optimal read gate delay duration for each zone of the hard disk drive in a memory accessible to a controller of the hard disk drive.

Preferably the method includes storing optimal read gate delays in a register of a memory and retrieving an optimal read gate delay from the register for use in a data read operation.

The invention also encompasses a method for reading from a location of a hard disk drive, the disk drive being of the type having read and write elements separated by an inter-element spacing and a plurality of radially spaced tracks, the method comprising the steps of:

interrogating a register containing a lookup table generated by the method described above; and

setting a read gate delay duration to a value retrieved from the register.

According to a further aspect of the present invention there is provided a computer program product stored on a computer readable memory and executable by a processor controlling a hard disk drive, for calculating an optimal read gate delay duration for a track of the hard disk drive, the computer program product including:

instructions for writing a bit pattern to the track;

instructions for making multiple reads of the bit pattern over a range of read gate delay durations;

instructions for calculating a read bit error rate for each of the multiple reads; and

instructions for setting the optimal read gate delay duration to the read gate delay duration having a minimal calculated read bit error rate.

Preferably the computer program product includes instructions for recording an optimal read gate delay duration in respect of each track of the hard disk drive.

The computer program product may also include instructions for recording an optimal read gate delay duration in respect of each zone of each track of the hard disk drive.

According to a further aspect of the present invention there is provided a hard disk of the type having read and write elements separated by an inter-element spacing and a plurality of radially spaced tracks, the hard disk drive including;

means for writing a bit pattern to a track of the hard disk drive;

means for making multiple reads of the bit pattern over a range of read gate delay durations;

means for calculating a read bit error rate for each of the multiple reads; and

means for setting an optimal read gate delay duration to a read gate delay duration of the range of read gate delay durations having a minimal calculated read bit error rate.

Preferably the hard disk drive includes means for recording an optimal read gate delay duration in respect of each track of the hard disk drive.

The hard disk drive may also include means for recording an optimal read gate delay duration in respect of each zone of each track of the hard disk drive.

According to another aspect of the invention there is provided a method for determining an optimal read gate delay for a radial position of a hard disk drive, the hard disk drive being of the type having read and write elements separated by an inter-element spacing, the method comprising the steps of:

measuring a parameter dependent on the inter-element spacing;

setting the optimal read gate delay as a function of the parameter.

Preferably the parameter comprises a bit error rate and the step of setting the read gate delay as a function of the parameter comprises setting the read gate delay to a read gate delay value at which a minimum bit error rate is recorded.

Alternatively the parameter may correspond to the inter-element spacing with the optimal read gate delay being a function of the inter-element spacing, a rate of rotation of the hard disk drive and the radial position.

### BRIEF DESCRIPTION OF THE DRAWINGS

FIG. 1 is a top view of a hard disk drive with top cover removed.

FIG. 2 is a close up view of a read/write head assembly showing the read and write elements and inter-element separation.

FIG. 3 is a close up view of a second read/write head assembly showing a narrower inter-element separation relative to that of FIG. 2.

FIG. 4 is a diagrammatic representation of a servo frame of a track of a hard disk, the rightmost field being the first field read in standard operation.

FIG. 5 is a block diagram of the controller circuitry of the hard disk drive.

FIG. 6 is schematic diagram of a read operation of a servo frame.

FIG. 7 is schematic diagram of a write operation.

FIG. 8 is a schematic diagram of the write operation of FIG. 7 at a later time.

FIG. 9 is a schematic diagram of read operation of a servo frame after the write operation of FIG. 6a.

FIG. 10 is a schematic diagram of the read operation of FIG. 9 at a later time.

FIG. 11 is a schematic diagram of a write operation utilizing a read/write head assembly with narrowed inter-element separation.

FIG. 12 is a schematic diagram of the write operation of FIG. 11 at a later time.

FIG. 13 is a schematic diagram of a read operation of a servo frame after the write operation of FIG. 12.

FIG. 14 is a schematic diagram of the read operation of FIG. 13 at a later time.

FIG. 15 is a schematic diagram of an embodiment of the present invention.

FIG. 16 is a flowchart of a method according to an embodiment of the present invention.

### DETAILED DESCRIPTION OF THE PREFERRED EMBODIMENT

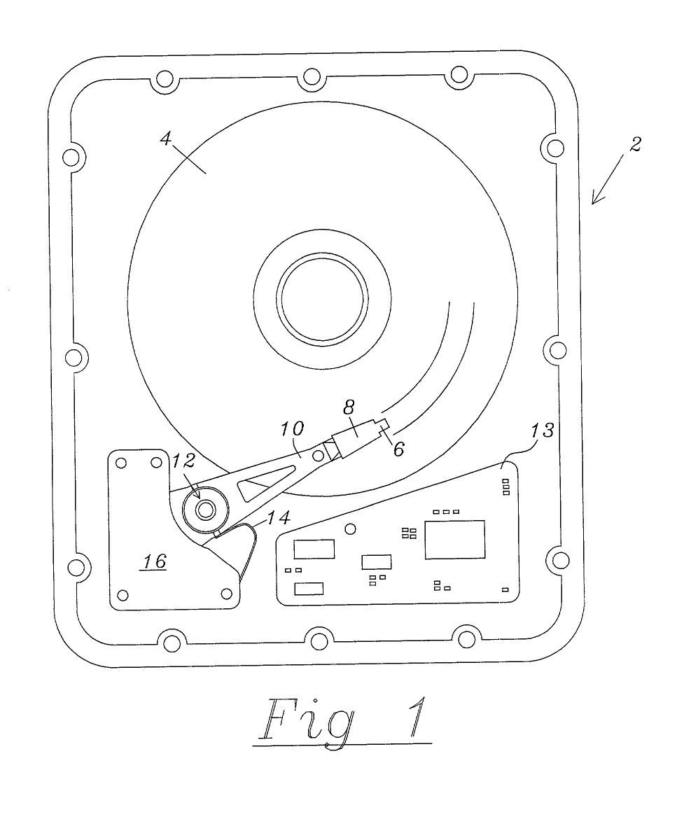

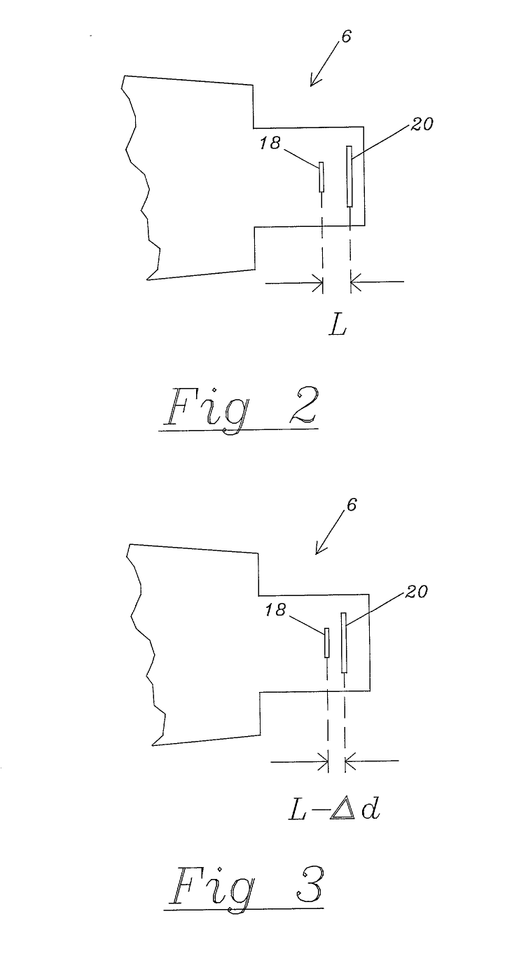

Referring again to FIG. 1, circuit board 13 contains signal processing and control circuitry as will be explained later with reference to FIG. 5. Read/write head 6 is supported by a slider 8 which glides over the surface of platter 4. Slider 8 is coupled to an actuator arm 10 which rotates about pivot assembly 12. The actuator arm is biased about the pivot by spring 14 against the action of a voice coil motor located beneath plate 16.

Modern disk drive architectures generally utilize an embedded servo system in which each data track is divided into a number of data sectors for storing fixed sized data blocks, one per sector. In addition, associated with the data sectors are a series of servo frames that are generally equally spaced around the circumference of the data track. The servo frames can be arranged between data sectors or arranged independently of the data sectors such that the servo frames split data fields of the data sectors, as is well known.

Typically each servo frame is radially aligned with corresponding servo frames of neighboring data tracks to form a set of radially extending, spoke-like servo sections that are equally spaced from one another around the circumference of the disk surface. However, when data are recorded in a zone bit arrangement, the number of data sectors within one rotation of a disk varies from zone to zone, thus causing the precise locations of servo frames of the spoke-like sections, relative to the data fields of the data sectors, to vary from zone-to-zone and within a zone.

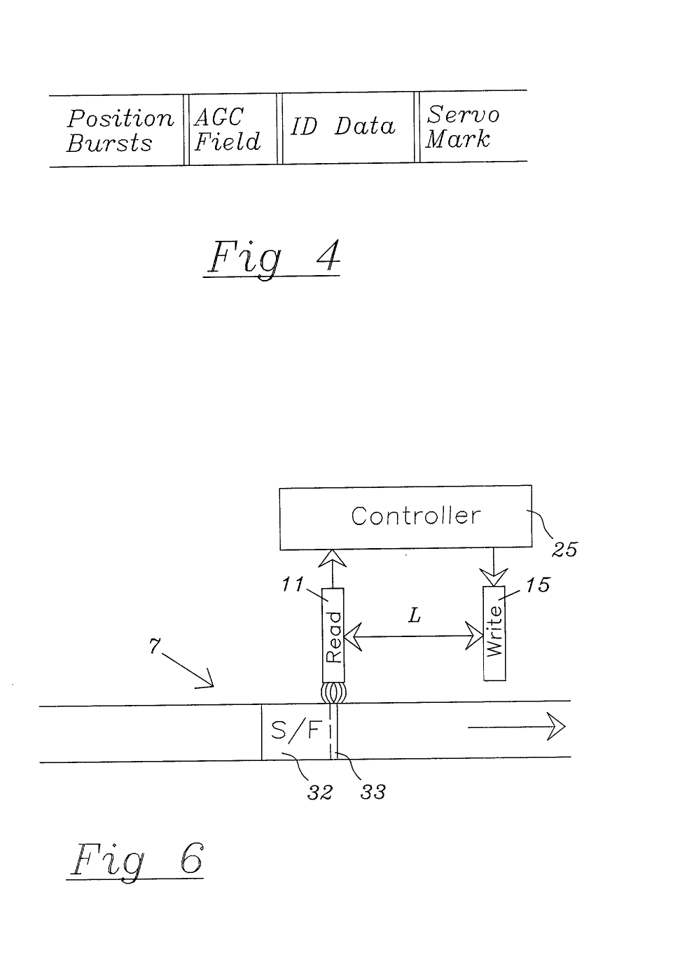

FIG. 4 depicts a servo frame sequence consisting of; firstly a Servo Mark, an AGC data field which may be used to set read sensitivity, an ID Data field which typically comprises digital data encoded with a grey code identifying the track number, and a Position Error Signal (PES) Field consisting of four position bursts. The position bursts generally consist of one or more cycles of continuous carrier spanning the track to be followed and adjacent tracks on either side. Following the servo bit sequence there a DC gap (not shown) after which user data is written to form a data sector as will be explained later.

Referring now to FIG. 5, there is depicted a block diagram of a typical hard-disk controller. The controller includes a bi-directional preamplifier 38 which is coupled to a read/write channel circuit 40. The read/write channel circuit contains AGC circuitry for normalizing the output from preamplifier 38. Read/write channel circuit 40 also includes demodulator circuitry for converting the analog signal from the read/write head 8 into a digital signal suitable for processing by processor 46. The processor controls a positioning driver 44 which provides positioning currents to voice coil motor 17. By means of spindle driver 52, microprocessor 46 also controls spindle motor 50 which is rotatably coupled to platter 4. An interface controller module 48 is provided to facilitate data communications between the hard disk and external computational devices such as a host computer.

Read/write channel circuit 40 also sends data signals to preamplifier 38. The write amplifier is configured to drive the write element of read/write head 8 in response to signals from preamplifier 38 thereby converting the data signals into magnetic dipoles on the surface of the platter.

Data segments of each track are typically encoded according to an error correcting code (ECC) which is decoded by channel circuit 40. Channel circuit 40 also includes logic circuits for detecting the servo mark fields of servo frames and for generating a servo gate signal when the servo mark of a data sector that is being searched for is located.

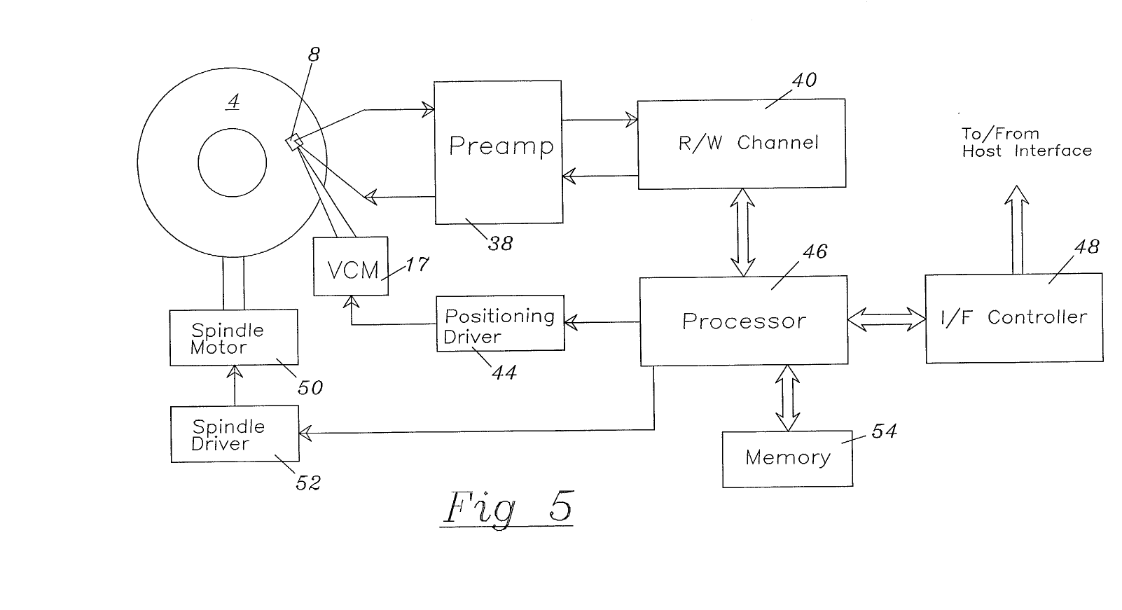

Referring now to FIG. 6 the sequence of events in writing data to a data sector following a servo frame 32 will be described. FIG. 6 depicts schematically a track 7 moving in the direction indicated by arrow 5 beneath read and write elements 11 and 15. Read and write elements 11 and 15 are electrically coupled to a controller comprising the system described in relation to FIG. 5. As the track moves beneath read head 11 the controller detects servo marker 33 and decodes the ID Data in the servo frame 32. The controller generates a SERVO_GATE flag upon determining that the ID Data corresponds to that of the servo frame that is being searched for.

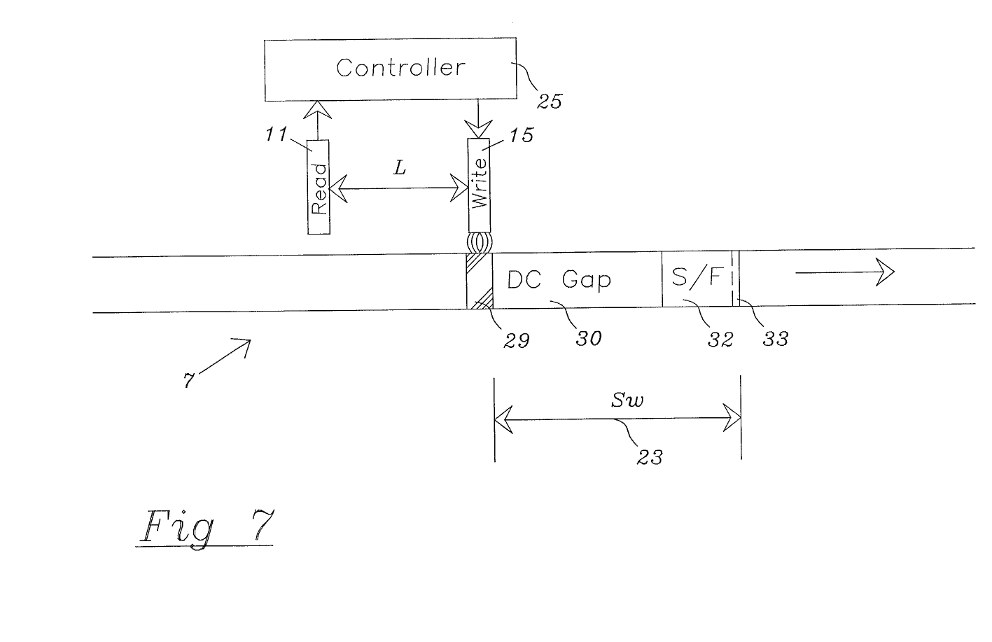

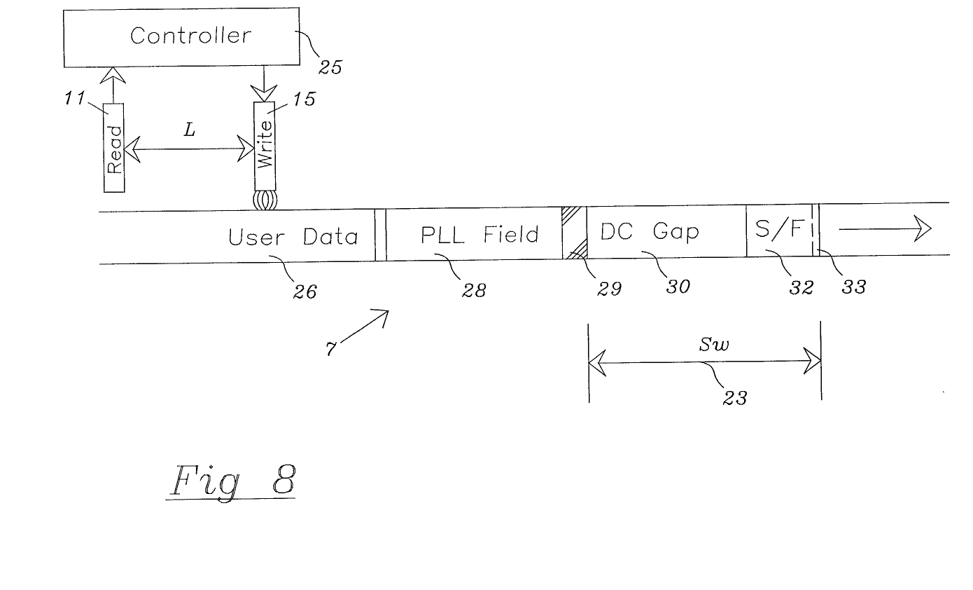

With reference to FIG. 7, after asserting the SERVO_GATE signal the controller waits for a write gate delay period to elapse before asserting a WRITE_GATE signal which initiates writing to the track. At the end of the write gate delay period the write head element is located at a distance Sw 23 from the servo marker. The commencement of writing causes a splice transient 29 which is an unwanted artifact that is unavoidable. A DC Gap 30 is left between the end of the servo frame 32 and the splice transient 29. Referring to FIG. 8, after the splice transient has settled a PLL Field 28 is written. The PLL Field is used by the controller during read operations to lock it to the read frequency for the zone thereby enabling correct reading of following user data. The user data 26 is written after the end of the PLL Field 28.

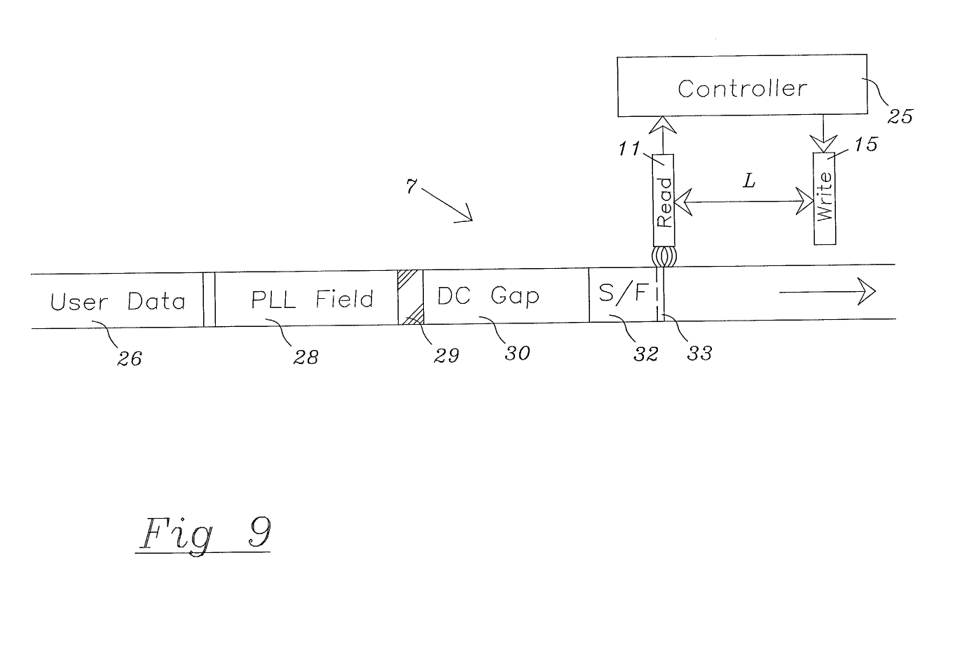

The sequence of events in reading data from the track will now be explained with reference to FIG. 9. Track 7 rotates under the read and write head elements 11 and 15 until the servo marker 33 for servo frame 32 is detected by controller 25.

Once the servo marker is detected and the ID Data field of sector 32 has verified the servo frame as being the one sought, then the controller asserts a SERVO_GATE.

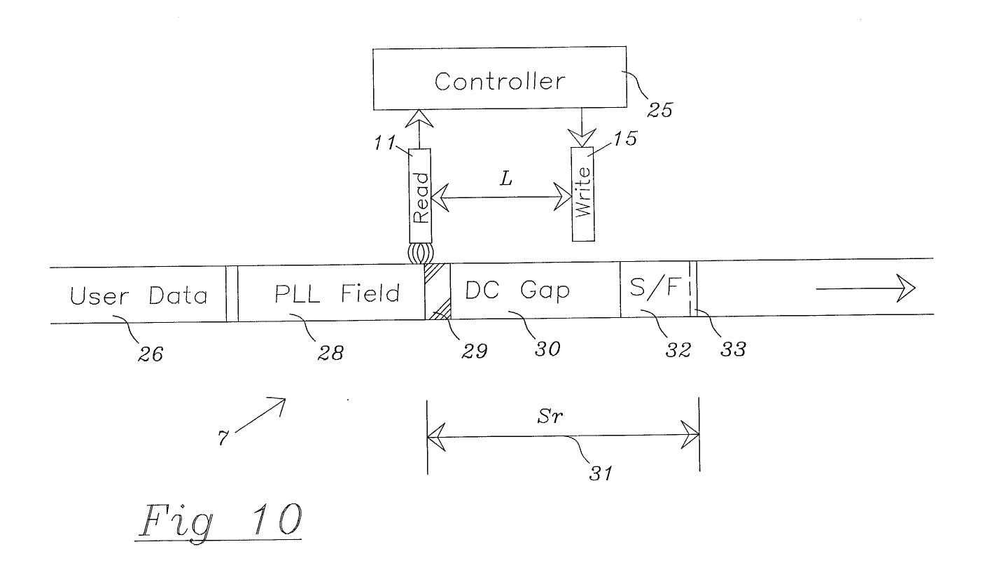

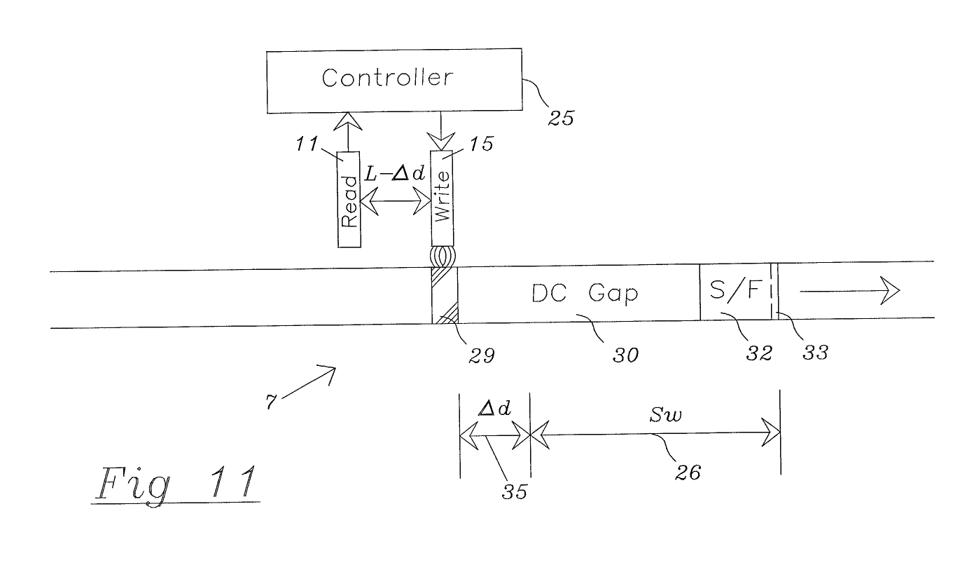

With reference to FIG. 10, after asserting the SERVO_GATE signal the controller waits for a write gate delay period to elapse before asserting a READ_GATE signal which initiates reading from the track.

At the end of the read gate delay period the read head element is located at a distance Sr 31 from the servo marker. It will noted that the gate delay period is sufficient for the track to move so that reading commences at the beginning of PLL Field 28 and after the splice transient 29 has settled. The controller locks onto the read frequency signal from the PLL Field and then reads the user data 26.

Statistically the present inventors have found that in any batch of MR head assemblies most will have about the same inter-element separation. However, there will be a variation so that some will have a narrower separation and some will have a wider separation. The variation is due to manufacturing processes. Units incorporating MR head assemblies in which the inter-element separation varies significantly from the usual separation are subject to read errors as will now be explained.

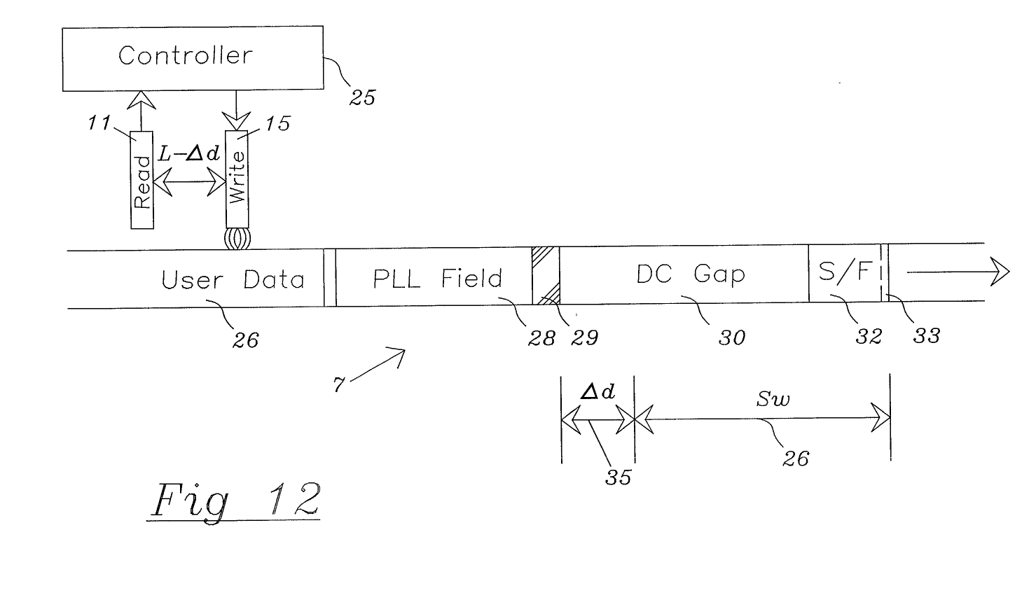

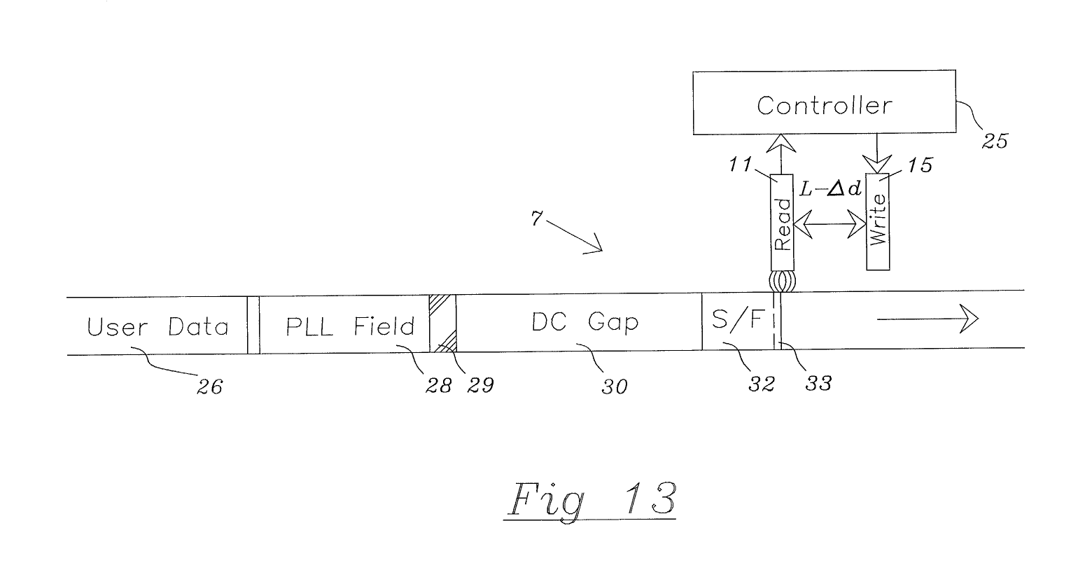

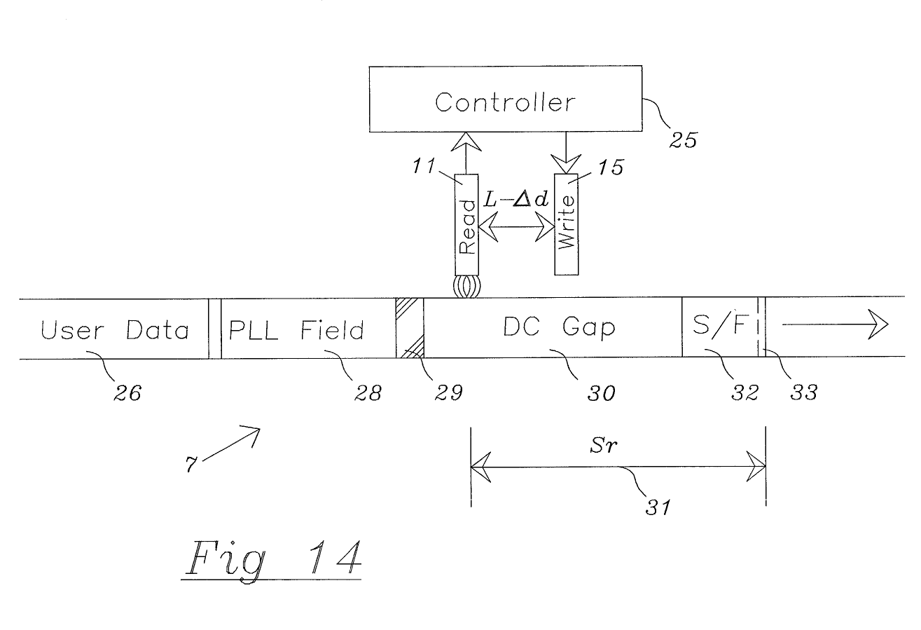

FIGS. 11 and 12 are similar to FIGS. 7 and 8 except that the distance between the read and write elements is narrowed by an amount Δd to L-Δd. The narrowing of the inter-element separation results in the writing operation commencing a distance Δd further away from the end of servo frame 32 as indicated by double-headed arrow 35. With reference to FIG. 13, during a read operation the controller detects servo frame 32 as previously described and waits for the read gate delay period to elapse before commencing reading. At the end of the read gate delay period the servo marker has moved a distance Sr downstream from the read head. As shown in FIG. 14 however, the distance Sr is insufficient as reading commences during the DC Gap 30. This is because Gap 30 has lengthened due to the narrowed spacing between the read and write head elements. The controller starts to lock onto the DC Gap expecting that the read head is over the PLL Field 28. Upon the read head coming adjacent splice transient 29 the controller will be thrown out of lock and may not recover until after the PLL Field has passed.

Accordingly a number of retries may be required before lock is correctly acquired and the user data is correctly read.

In the case where the inter-element separation is wider, rather than narrower, the DC Gap will be shorter than expected and the reading operation may commence towards the end of the PLL Field.

In that case there may not be a sufficient duration of PLL Field signal for the controller to lock so that it is able to correctly read the user data field 26. Once again a number of retries may be required before the user data is correctly read.

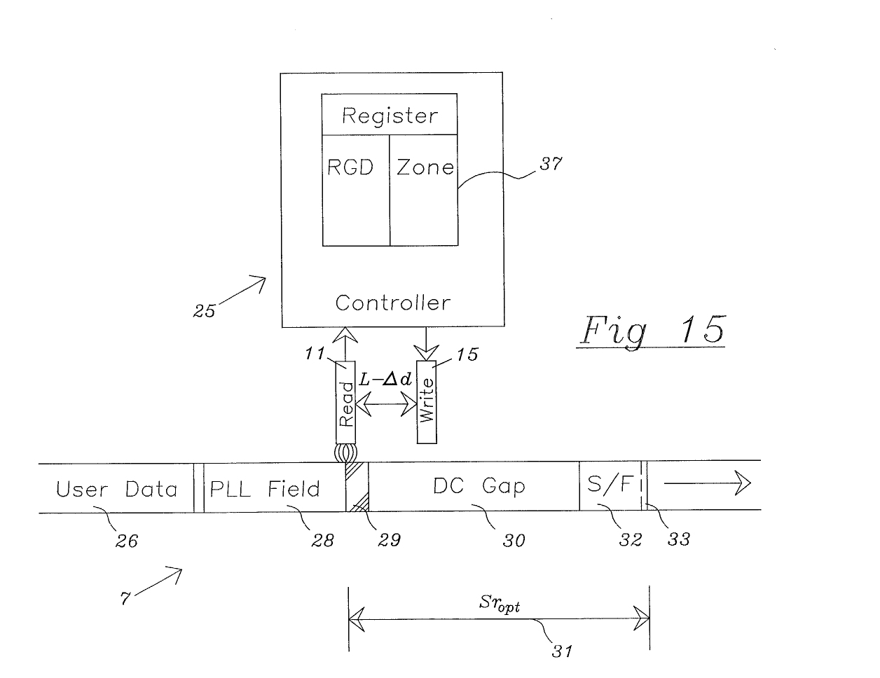

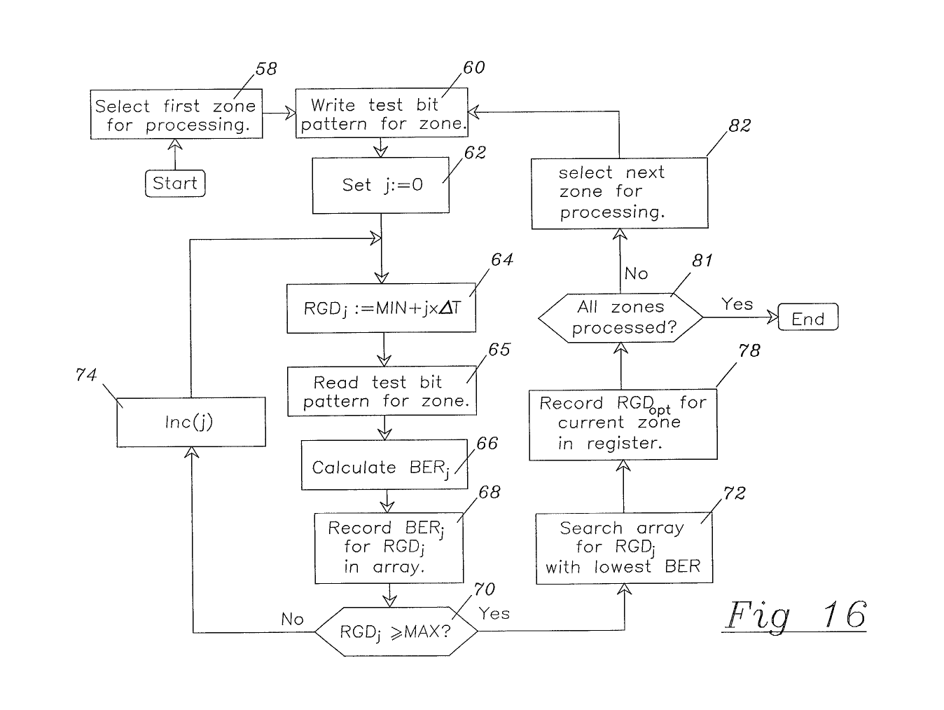

FIG. 15 schematically illustrates a hard disk drive according to an embodiment of the present invention. Controller 25 includes a memory device 37 which implements a register that records the optimum read gate delay for each zone. Alternatively the register may be implemented by means of standard on-board memory 54 of FIG. 5. The optimum read gate delay for each zone is determined by measuring the inter-element separation using the standard error rate monitoring function of the read/write channel chip, as will now be explained with reference to FIG. 16. As a result the read delay is optimized so that at the end of the read gate delay read head 11 is located a distance Sᵣₒₚₜ from servo marker 33 and is correctly positioned over the start of PLL Field 28 at the time that reading commences.

FIG. 16 is a flowchart of a method, according to an embodiment of the present invention, for determining an optimal read gate delay for each zone. (Where a zoned bit data arrangement is not used the register may record the optimum read gate delay for each track.) Initially at step 58 an initial zone for processing is selected. Then at step 60 a predetermined test bit pattern is written to the data sector of the zone. At step 62 a counter variable j is initialized to zero. At step 64 read gate delay variable RGDⱼ is set to MIN+j×ΔT where MIN is a delay value that corresponds to the narrowest inter-element separation that might feasibly occur and ΔT is a small delay value. At step 65 the test bit pattern is read using the current RGDᵢⱼ and at step 65 a bit error rate (BER) calculated and stored in variable BERⱼ. The BER is a parameter that is dependent on the inter-element spacing.

At step 66 the test bit pattern is read and a bit error rate (BER) is calculated and assigned to variable BERⱼ. BERⱼ is recorded in a data array against the value of RGDⱼ at step 68. At step 70 RGDᵢ is compared to a constant MAX which is a maximum read gate delay value corresponding to the widest inter-element separation that might feasibly occur.

If RGDᵢ is less than the MAX value then control diverts to step 74 where counter variable j is incremented thereby increasing the value of RGDⱼ at step 64. The procedure loops through step 74 for j=1, . . . ,n until RGDⱼ is greater than or equal to MAX at step 70. Control then diverts to step 72. At step 72 a search of the array is performed to locate RGDₒₚₜ being the RGDⱼ having the lowest corresponding BER. That value is recorded in register 37 (FIG. 15) as being the optimal read gate delay RGDₒₚₜ for the current zone. The procedure is then repeated via steps 81 and 80 until the optimal read gate delay has been recorded in register 37 for each zone.

The above method is implemented in software or firmware that may be stored in memory 54 (FIG. 5). The instructions that implement each of the steps of the flowchart of FIG. 16 may be coded in any suitable computational language for execution by processor 46 and form a computer program product. The computer program product is stored on a computer readable memory, either in an integrated circuit memory device, for example memory 54 as mentioned above, or externally on a passive substrate such as a magnetic or optical media, and is executable by a processor controlling the hard disk drive. The processor may be onboard processor 46 of FIG. 5 or it may be a processor in a host computer that is interfaced to the hard disk drive.

Referring again to FIG. 15, during a read operation at the point that the controller sets the gate delay period the gate delay is obtained by looking up the value of RGDₒₚₜ corresponding to the current zone. The values stored in register 37 will vary from disk drive to disk drive depending on the inter-element separation of the head assembly in each particular disk drive unit.

It will be realized that while the method of FIG. 16 is most convenient other methods for calculating the optimal read gate delay for each zone might be employed. For example one alternative approach would be to commence reading shortly after the servo frame and to measure the time period to the detection of the following splice transient. The read gate delay could then be set to correspond to a the measured time period plus a time sufficient to accommodate passing of the splice transient beneath the read head.

Other methods based on directly measuring the inter-element separation might also be used.

It will be realized that where the inter-element spacing is estimated the optimal read gate delay may be calculated as a function of the inter-element spacing, the rate of rotation of the platters of the hard disk drive and the radial position at which the read operation is taking place.

Although the present invention has been described with reference to preferred embodiments, workers skilled in the art will recognize that changes may be made in form and detail without departing from the spirit and scope of the invention.

Accordingly, it is to be expressly understood that the claimed invention is not to be limited to the description of the preferred embodiment but encompasses other modifications and alterations within the scope of the inventive concept.

It is to be understood that the foregoing disclosure is illustrative only, and changes may be made within the principles of the present invention to the full extent indicated by the broad general meaning of the terms in which the appended claims are expressed. Although the preferred embodiment described herein is directed to a disk drive for a personal computer, it will be appreciated by those skilled in the art that the teaching of the present invention can be applied to other systems without departing from the scope and spirit of the present invention.

We claim:

1. A method for determining an optimal read gate delay duration for reading from a track of a hard disk drive, the disk drive being of the type having read and write elements separated by an inter-element spacing and a plurality of radially spaced tracks, the method comprising the steps of:
writing a bit pattern to the track;
reading the bit pattern with each of a range of read gate delay durations;
calculating a read bit error rate for each said duration; and
setting the optimal read gate delay to the delay duration corresponding to the lowest read bit error rate.

2. A method according to claim 1 further including the step of determining the optimal read gate delay duration for each track of the hard disk drive.

3. A method according to claim 2 further including the step of recording the optimal read gate delay duration for each track of the hard disk drive in a memory device accessible to a controller of the hard disk drive.

4. A method according to claim 1 wherein data is encoded on the tracks according to a zoned bit arrangement, the method further including the step of recording the optimal read gate delay duration for each zone of the hard disk drive in a memory accessible to a controller of the hard disk drive.

5. A method according to claim 1, further including:
storing optimal read gate delays in a register of a memory; and
retrieving an optimal read gate delay from the register for use in a data read operation.

6. A computer program product stored on a computer readable memory and executable by a processor controlling a hard disk drive, for calculating an optimal read gate delay duration for a track of the hard disk drive, the computer program product including:
instructions for writing a bit pattern to the track;
instructions for making multiple reads of the bit pattern over a range of read gate delay durations;
instructions for calculating a read bit error rate for each of the multiple reads; and
instructions for setting the optimal read gate delay duration to the read gate delay duration having a minimal calculated read bit error rate.

7. A computer program product according to claim 6 further including instructions for recording an optimal read gate delay duration in respect of each track of the hard disk drive.

8. A computer program product according to claim 6 further including instructions for recording an optimal read gate delay duration in respect of each zone of each track of the hard disk drive.

9. A hard disk of the type having read and write elements separated by an inter-element spacing and a plurality of radially spaced tracks, the hard disk drive including;
means for writing a bit pattern to a track of the hard disk drive;
means for making multiple reads of the bit pattern over a range of read gate delay durations;
means for calculating a read bit error rate for each of the multiple reads; and
means for setting an optimal read gate delay duration to a read gate delay duration of the range of read gate delay durations having a minimal calculated read bit error rate.

10. A hard disk drive according to claim 9 further including means for recording an optimal read gate delay duration in respect of each track of the hard disk drive.

11. A hard disk drive according to claim 9 further including means for recording an optimal read gate delay duration in respect of each zone of each track of the hard disk drive.

12. A method for determining an optimal read gate delay for a radial position of a hard disk drive, the hard disk drive being of the type having read and write elements separated by an inter-element spacing, the method comprising the steps of:
measuring a parameter dependent on the inter-element spacing;
setting the optimal read gate delay as a function of the parameter.

13. A method according to claim 12, wherein the parameter comprises a bit error rate and wherein the step of setting the read gate delay as a function of the parameter comprises setting the read gate delay to a read gate delay value at which a minimum bit error rate is recorded.

14. A method according to claim 13, wherein the parameter corresponds to the inter-element spacing and wherein the optimal read gate delay is a function of the inter-element spacing, a rate of rotation of the hard disk drive and the radial position.
